(19) United States
(12) Patent Application Publication
(10) Pub. No.: US 2025/0028036 A1
(43) Pub. Date: Jan. 23, 2025

(54) POSITIONING METHOD AND MULTI-RADAR POSITIONING SYSTEM

(71) Applicant: Wistron Corporation, New Taipei City (TW)

(72) Inventors: Yin-Yu Chen, New Taipei City (TW); Yu-Wen Huang, New Taipei City (TW); Kaijen Cheng, New Taipei City (TW); Tsung-Yin Tsou, New Taipei City (TW); Yao-Tsung Chang, New Taipei City (TW)

(73) Assignee: Wistron Corporation, New Taipei City (TW)

(21) Appl. No.: 18/462,424

(22) Filed: Sep. 7, 2023

(30) Foreign Application Priority Data
Jul. 17, 2023 (TW) 112126535

(51) Int. Cl. G01S 13/42; G01S 13/87

(52) U.S. Cl. CPC G01S 13/42; G01S 13/87

(57) ABSTRACT

A positioning method and a multi-radar positioning system are provided. In the positioning method, a first object and a second object are detected by a first radar to obtain a first coordinate and a second coordinate on a first coordinate system respectively. The first object and the second object are detected by a second radar to obtain a third coordinate and a fourth coordinate on a second coordinate system respectively. A first candidate coordinate and a second candidate coordinate of the second radar on the first coordinate system are estimated according to the third coordinate and the fourth coordinate. The first candidate coordinate is selected from the first candidate coordinate and the second candidate coordinate as a first radar coordinate of the second radar according to the first coordinate and the second coordinate. The first radar coordinate is output.

### CROSS-REFERENCE TO RELATED APPLICATION

This application claims the priority benefit of Taiwan application serial no. 112126535, filed on Jul. 17, 2023. The entirety of the above-mentioned patent application is hereby incorporated by reference herein and made a part of this specification.

### BACKGROUND

### Technical Field

The disclosure relates to a positioning technology, and particularly relates to a positioning method and a multi-radar positioning system.

### Description of Related Art

A radar system may be used for high-precision positioning. If a millimeter wave radar is used, a positioning error may be reduced to centimeters. Compared to positioning systems based on communication protocols such as Bluetooth, WiFi, Radio Frequency Identification (RFID), or ZigBee, etc., the radar system may achieve positioning in a privacy free manner without collecting data on the user's mobile device. Therefore, the radar system has gradually replaced a photographic system to serve as an indoor positioning system.

The radar system has a number of disadvantages. For example, detection of a radar is limited by a detection distance, and a detection result may be interfered by a barrier effect. In order to solve the above problems, the radar system often uses a multiple radar fusion technology. When installing multiple radars of the radar system in a field, a user must first obtain a global map of the field and installation positions of the radars. In this way, after the detection results are obtained, the radar system may perform positioning based on the global map and the radar positions. However, the acquisition of the global map and the radar positions requires manpower and time.

### SUMMARY

The disclosure is directed to a positioning method and a multi-radar positioning system, which are adapted to automatically convert detection results of a plurality of radars to a same coordinate system.

An embodiment of the disclosure provides a multi-radar positioning system including a first radar, a second radar and a controller. The first radar detects a first object and a second object to respectively obtain a first coordinate and a second coordinate on a first coordinate system. The second radar detects the first object and the second object to respectively obtain a third coordinate and a fourth coordinate on a second coordinate system. The controller is communicatively coupled to the first radar and the second radar and is configured to: estimate a first candidate coordinate and a second candidate coordinate of the second radar on the first coordinate system according to the third coordinate and the fourth coordinate; select the first candidate coordinate from the first candidate coordinate and the second candidate coordinate as a first radar coordinate of the second radar according to the first coordinate and the second coordinate; and output the first radar coordinate.

An embodiment of the disclosure provides a positioning method, adapted to a multi-radar positioning system including a first radar and a second radar. The positioning method includes: detecting a first object and a second object by the first radar to respectively obtain a first coordinate and a second coordinate on a first coordinate system; detecting the first object and the second object by the second radar to respectively obtain a third coordinate and a fourth coordinate on a second coordinate system; estimating a first candidate coordinate and a second candidate coordinate of the second radar on the first coordinate system according to the third coordinate and the fourth coordinate; selecting the first candidate coordinate from the first candidate coordinate and the second candidate coordinate as a first radar coordinate of the second radar according to the first coordinate and the second coordinate; and outputting the first radar coordinate.

Based on the above description, the multi-radar positioning system of the disclosure is adapted to automatically obtain relative positions of the radars, and then convert the detection results of the radars into a same coordinate system.

### BRIEF DESCRIPTION OF THE DRAWINGS

FIG. 1 is a schematic diagram of a multi-radar positioning system according to an embodiment of the disclosure.

FIG. 2 is a flowchart of a positioning method according to an embodiment of the disclosure.

FIG. 3 is a schematic diagram of radars and objects in a space according to an embodiment of the disclosure.

FIG. 4 is a schematic diagram of obtaining two candidate coordinates according to an embodiment of the disclosure.

FIG. 5 is a schematic diagram of obtaining a single candidate coordinate according to an embodiment of the disclosure.

FIG. 6 is a schematic diagram of obtaining a radar coordinate of a radar by using detection results of two objects according to an embodiment of the disclosure.

FIG. 7 is a schematic diagram of obtaining a radar coordinate of a radar by using detection results of three objects according to an embodiment of the disclosure.

FIG. 8 is a schematic diagram of mapping a radar coordinate of a radar to a reference coordinate system according to an embodiment of the disclosure.

FIG. 9 is a flowchart of obtaining an included angle θ₀ according to an embodiment of the disclosure.

FIG. 10 is a schematic diagram of obtaining the included angle θ₀ when an included angle θ₁ is greater than 90 degrees according to an embodiment of the disclosure.

FIG. 11 is a schematic diagram of obtaining the included angle θ₀ when the included angle θ₁ is less than or equal to 90 degrees according to an embodiment of the disclosure.

FIG. 12 is a schematic diagram of radars and objects in a three-dimensional space according to an embodiment of the disclosure.

FIG. 13 is a schematic diagram of mapping coordinates of radars and an object to an XY plane according to an embodiment of the disclosure.

FIG. 14 is a flowchart of a positioning method according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like elements/parts/steps.

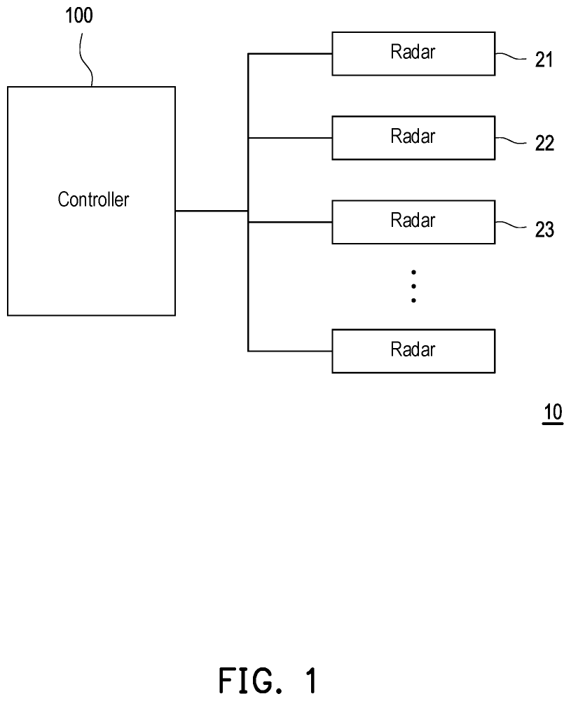

FIG. 1 is a schematic diagram of a multi-radar positioning system 10 according to an embodiment of the disclosure. The multi-radar positioning system 10 may include a controller 100 and a plurality of radars, where the plurality of radars include a radar 21, a radar 22 and a radar 23, for example. The controller 100 may be directly electrically connected, indirectly electrically connected or communicatively connected to the plurality of radars.

The controller 100 may include a central processing unit (CPU), or other programmable general purpose or special purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable logic gate array (FPGA) or other similar devices or a combination of the above devices. The controller 100 may further include a communication unit (for example: various communication chips, a mobile communication chip, a Bluetooth chip or a WiFi chip) and a storage unit (for example: a removable random access memory, a flash memory or a hard disk) and other necessary components for running the controller 100.

The controller 100 may detect an object in the field through a radar (for example: the radar 21, 22 or 23) to generate a detection result. The detection result may include a coordinate of the object on a coordinate system corresponding to the radar, where the coordinate may include information such as a distance between the object and the radar and a direction (or an angle of arrival (AoA)) of the object relative to the radar, etc. In an embodiment, the controller 100 may obtain the coordinate of the object according to the detection result of the radar (for example, a point cloud of the object detected by the radar) based on an object detection (object detection) algorithm or a machine learning (ML) algorithm.

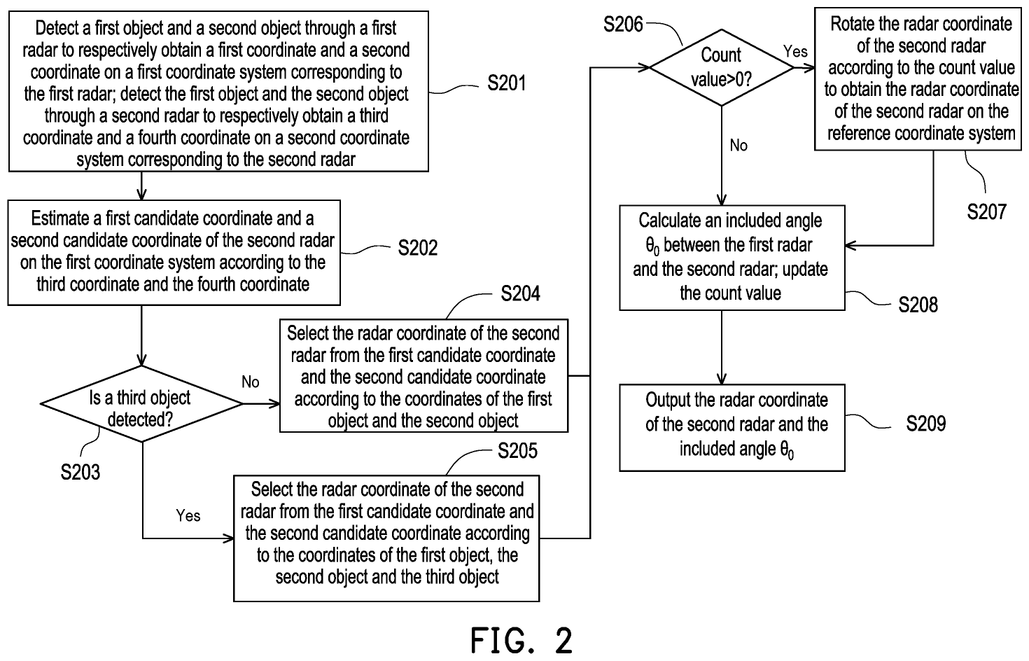

FIG. 2 is a flowchart of a positioning method according to an embodiment of the disclosure, where the positioning method may be implemented by the multi-radar positioning system 10 shown in FIG. 1.

In step S201, the controller 100 detects a first object and a second object through a first radar to respectively obtain a first coordinate and a second coordinate on a first coordinate system corresponding to the first radar. On the other hand, the controller 100 detects the first object and the second object through a second radar to respectively obtain a third coordinate and a fourth coordinate on a second coordinate system corresponding to the second radar.

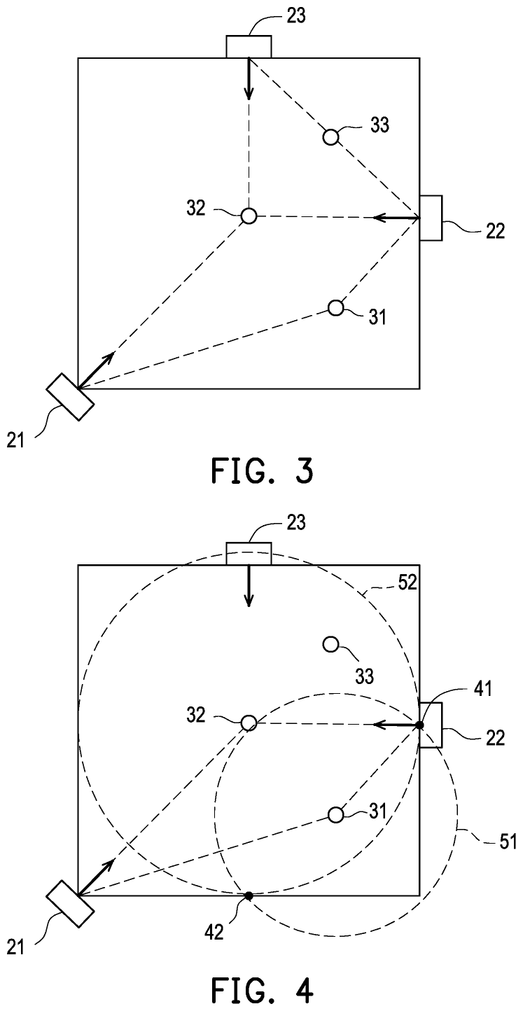

FIG. 3 is a schematic diagram of radars and objects in a space according to an embodiment of the disclosure. It is assumed that a plurality of radars including the radar 21, the radar 22 and the radar 23 are configured in the space, and an object 31, an object 32 and an object 33 exist in the space. The coordinate of each object is represented by C(i, j), where i represents an index of the object, and j represents an index of the coordinate system (or radar) corresponding to the coordinate of the object. The aforementioned coordinate is, for example, a two-dimensional coordinate or three-dimensional coordinate.

The controller 100 may detect the object 31 through the radar 21 to obtain a coordinate C(31, 21)=(3.54, 7.07) on the coordinate system (or referred to as a reference coordinate system) corresponding to the radar 21, and may detects the object 32 through the radar 21 to obtain a coordinate C(32, 21)=(0, 7.07) on the coordinate system corresponding to the radar 21. The object 31 and the object 32 may be different objects, or may be the same object. For example, if the object 31 and the object 32 are the same object, due to movement of the object, coordinates of different displacements are generated. On the other hand, the controller 100 may detect the object 31 through the radar 22 to obtain a coordinate C(31, 22)=(−2.5, 2.5) on a coordinate system of the radar 22, and may detect the object 32 through the radar 22 to obtain a coordinate C(32, 22)=(0, 5) on the coordinate system corresponding to the radar 22, and may detect the object 33 through the radar 22 to obtain a coordinate C(33, 22)=(2.5, 2.5) on the coordinate system corresponding to the radar 22. Moreover, the controller 100 may detect the object 32 through the radar 23 to obtain the coordinate C(32, 23)=(0, 5) on the coordinate system corresponding to the radar 23, and may detect the object 33 through the radar 23 to obtain the coordinate C(33, 23)=(−2.5, 2.5) on the coordinate system corresponding to the radar 23.

Referring to FIG. 2 and FIG. 3, in the following it is assumed that the radar 21 corresponds to the first radar, the radar 22 corresponds to the second radar, the coordinate C(31, 21) corresponds to the first coordinate on the first coordinate system, the coordinate C(32, 21) corresponds to the second coordinate on the first coordinate system, the coordinate C(31, 22) corresponds to the third coordinate on the second coordinate system, and the coordinate C(32, 22) corresponds to the fourth coordinate on the second coordinate system. It should be noted that a detection range of the radar 21 partially overlaps with a detection range of the radar 22, and both of the object 31 and the object 32 are located within the partially overlapped range. The radar 21 detects the object 31 and the object 32 and obtains point clouds of the object 31 and the object 32. The radar 21 obtains point cloud centroid point coordinates, i.e. coordinates C, by calculating point cloud centroid points of the object 31 and the object 32. Comparatively, the radar 22 detected the object 31 and the object 32, and uses an object detection algorithm or a machine learning algorithm to determine features such as object shapes, skeletons, heights, widths, or movement speeds of the object 31 and the object 32 based on point cloud distribution points, so as to determine that the object 31 and the object 32 detected by the radar 22 are respectively the object 31 and the object 32 detected by the radar 21.

In step S202, the controller 100 estimates a first candidate coordinate and a second candidate coordinate of the second radar on the first coordinate system according to the third coordinate and the fourth coordinate. Specifically, the controller 100 may obtain the third coordinate from a detection result of the second radar, and determine a first distance between the first object and the second radar according to the third coordinate. In addition, the controller 100 may obtain the fourth coordinate from the detection result of the second radar, and determine a second distance between the second object and the second radar according to the fourth coordinate. Then, the controller 100 may search for a fifth coordinate on the first coordinate system. If a third distance between the fifth coordinate and the first coordinate is equal to a first distance between the third coordinate and the second radar, and a fourth distance between the fifth coordinate and the second coordinate is equal to a fourth distance between the fourth coordinate and the second radar, the controller 100 may determine that the fifth coordinate is a candidate coordinate. The controller 100 may obtain one or two candidate coordinates (i.e.: the first candidate coordinate and/or the second candidate coordinate) according to the above steps.

FIG. 4 is a schematic diagram of obtaining two candidate coordinates according to an embodiment of the disclosure. The controller 100 may estimate a candidate coordinate C(41, 21) of a candidate position 41 of the radar 22 on the coordinate system (i.e., the reference coordinate system) corresponding to the radar 21 and a candidate coordinate C(42, 21) of a candidate position 42 of the radar 22 on the coordinate system corresponding to the radar 21 according to the coordinate C(31, 22) and the coordinate C(32, 22). To be specific, the controller 100 may determine a distance between the object 31 and the radar 22 to be \sqrt{(−2.5)²+(2.5)²}=3.54 according to the coordinate C(31, 22), and may draw a circle 51 with a radius of the distance (3.54) while taking the object 31 as a center, where a circle equation of the circle 51 may be (x−3.54)²+(y−7.07)²=(−2.5)²+(2.5)². The controller 100 may further determine a distance between the object 32 and the radar 22 to be \sqrt{0²+5²}=5, and may draw a circle 52 with a radius of the distance (5) while taking the object 32 as a center, where a circle equation of the circle 52 may be (x−0)²+(y−7.07)²=(0)²+ (5)². The controller 100 may calculate coordinates of two intersections of the circle 51 and the circle 52 according to the circle equation of the circle 51 and the circle equation of the circle 52, which are respectively the coordinate C(41, 21)=(3.54, 10.60) of the position 41 and the coordinate C(42, 21)=(3.54, 3.54) of the position 42. Since the distance between the coordinate C(41, 21) of the position 41 and the coordinate C(31, 21) is equal to the distance between the object 31 and the radar 22, the controller 100 may determine that the position 41 is a candidate position and the coordinate C(41, 21) is a candidate coordinate. On the other hand, since the distance between the coordinate C(42, 21) of the position 42 and the coordinate C(32, 21) is equal to the distance between the object 32 and the radar 22, the controller 100 may determine that the position 42 is a candidate position and the coordinate C(42, 21) is a candidate coordinate. In the following description, it is assumed that the coordinate C(41, 21) is a first candidate coordinate, and the coordinate C(42, 21) is a second candidate coordinate.

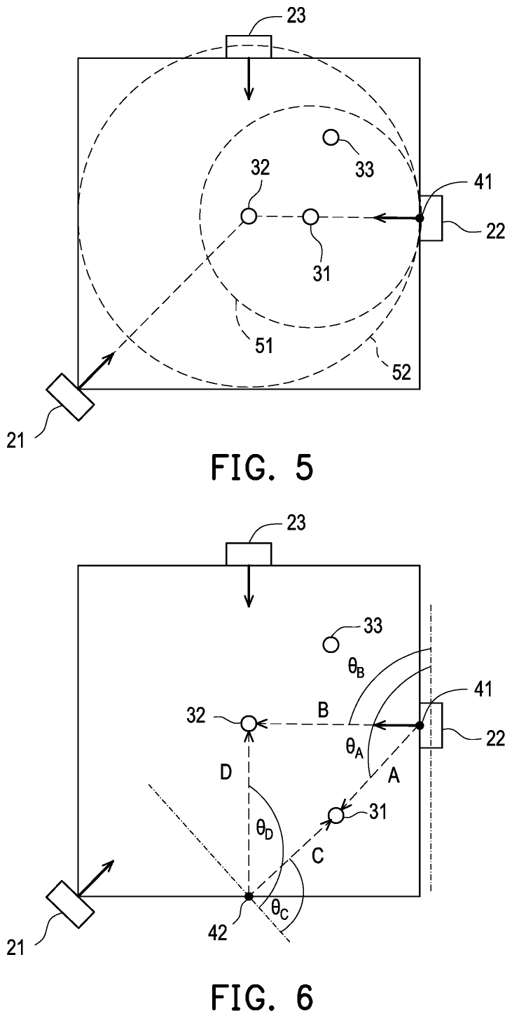

FIG. 5 is a schematic diagram of obtaining a single candidate coordinate according to an embodiment of the disclosure. The controller 100 may estimate the candidate coordinate C(41, 22) of the candidate position 41 of the radar 22 on the coordinate system corresponding to the radar 21 (i.e.: the reference coordinate system) according to the coordinate C(31, 22) and the coordinate C(32, 22). To be specific, the controller 100 may determine a distance between the object 31 and the radar 22 according to the coordinate C(31, 22), and draw a circle 51 with a radius of the distance while taking the object 31 as a center. The controller 100 may also determine a distance between the object 32 and the radar 22 according to the coordinate C(32, 22), and draw a circle 52 with a radius of the distance while taking the object 32 as a center. Since the circle 51 is tangent to the circle 52, the intersection of the circle 51 and the circle 52 only includes the position 41. Since the distance between the coordinate C(41, 21) of the position 41 and the coordinate C(31, 21) is equal to the distance between the object 31 and the radar 22, the controller 100 may determine that the position 41 is a candidate position and the coordinate C(41, 21) is a candidate coordinate. If the controller 100 obtains only a single candidate coordinate in step S202, the controller 100 may skip steps S203 to S205 and directly determine that the candidate coordinate is a radar coordinate (or referred to as a first radar coordinate) of the second radar on the first coordinate system corresponding to the first radar. In the following, it is assumed that the coordinate C(41, 21) is the first candidate coordinate.

Referring back to FIG. 2, in step S203, the controller 100 may determine whether the first radar and the second radar detect a third object. If both the first radar and the second radar detect the third object, step S205 is executed. If at least one of the first radar and the second radar does not detect the third object, step S204 is executed.

In step S204, the controller 100 may select the radar coordinate of the second radar from the first candidate coordinate and the second candidate coordinate according to the coordinates of the first object and the second object. Specifically, the controller 100 may obtain a first vector from the first candidate coordinate to the first coordinate, and obtain a second vector from the first candidate coordinate to the second coordinate. In addition, the controller 100 may obtain a first angle of arrival according to the third coordinate, and obtain the second angle of arrival according to the fourth coordinate. Then, the controller 100 may rotate the first vector according to the first angle of arrival to obtain a third vector, and rotate the second vector according to the second angle of arrival to obtain a fourth vector. The controller 100 may calculate a first included angle between the third vector and the fourth vector, where the first included angle corresponds to the first candidate coordinate. Based on similar steps, the controller 100 may calculate a second included angle corresponding to the second candidate coordinate. If an absolute value of the first included angle is smaller than an absolute value of the second included angle, the controller 100 may select the first candidate coordinate from the first candidate coordinate and the second candidate coordinate to serve as the radar coordinate of the second radar.

FIG. 6 is a schematic diagram of obtaining the radar coordinate of the radar 22 by using detection results of two objects according to an embodiment of the disclosure. The controller 100 may obtain a vector A=(0,−3.54) from the candidate coordinate C(41, 21) to the coordinate C(31, 21), and can obtain a vector B=(−3.54,−3.54) from the candidate coordinate C(41, 21) to the coordinate C(32, 21). Moreover, the controller 100 may obtain an angle of arrival θ_{A}=135° according to the coordinate C(31, 22), and obtain an angle of arrival θ_{B}=90° according to the coordinate C(32, 22). Then, the controller 100 may rotate the vector A clockwise by the angle of arrival θ_{A} to obtain a vector A′=(−2.5, 2.5) (not shown in the figure), and rotate the vector B clockwise by the angle of arrival OB to obtain a vector B′=(−3.54, 3.54) (not shown in the figure). The controller 100 may calculate an included angle ∠A′B′=0° between the vector A′ and the vector B′. Since the candidate coordinate C(41, 21) is a real coordinate of the radar 22, an absolute value of the included angle ∠A′B′ should be zero.

On the other hand, the controller 100 may obtain a vector C=(0, 3.54) from the candidate coordinate C(42, 21) to the coordinate C(31, 21), and obtain a vector D=(−3.54, 3.54) from the candidate coordinate C(42, 21) to the coordinate C(32, 21). Then, the controller 100 may rotate the vector C clockwise by the angle of arrival θ_{A} to obtain a vector C′=(2.5,−2.5) (not shown in the figure), and rotate the vector D clockwise by the angle of arrival θ_{B} to obtain a vector D′=(3.54, 3.54) (not shown in the figure). The controller 100 may calculate an angle ∠C′D′=90° or 270° between the vector C′ and the vector D′. Since the angle of arrival corresponding to vector C should be θ_{C} instead of θ_{A}, and the angle of arrival corresponding to vector D should be θ_{D} instead of θ_{B}, the absolute value of the included angle ∠C′ D′ should be greater than zero. Accordingly, the controller 100 may select the candidate coordinate C(41, 21) corresponding to ∠A′B′ from the candidate coordinate C(41, 21) and the candidate coordinate C(42, 21) to serve as the radar coordinate of the radar 22 in response to the fact that the absolute value of the included angle ∠A′B′ is smaller than the absolute value of the included angle ∠C′D′.

Referring back to FIG. 2, in step S205, the controller 100 may select the radar coordinate of the second radar from the first candidate coordinate and the second candidate coordinate according to the coordinates of the first object, the second object and the third object. To be specific, the controller 100 may detect the third object through the first radar to obtain a fifth coordinate on the first coordinate system, and detect the third object through the second radar to obtain a sixth coordinate on the second coordinate system. Then, the controller 100 may calculate a first distance between the first candidate coordinate and the fifth coordinate, and obtain a second distance between the sixth coordinate and the second radar. If the first distance is equal to the second distance, the controller 100 may select the first candidate coordinate as the radar coordinate of the radar 22.

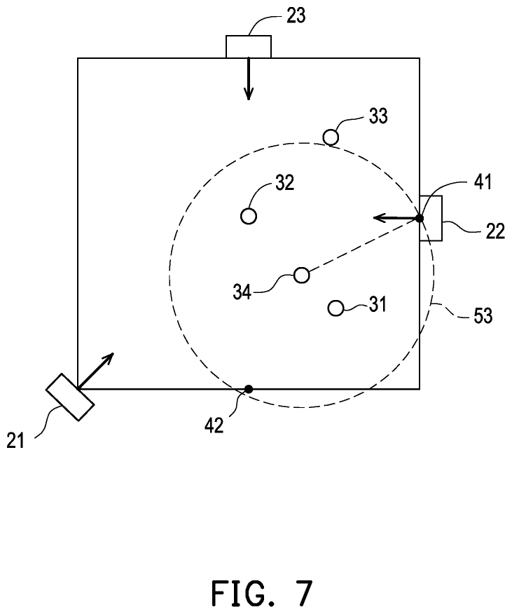

FIG. 7 is a schematic diagram of obtaining the radar coordinate of the radar 22 by using detection results of three objects according to an embodiment of the disclosure. The controller 100 may detect an object 34 through the radar 21 to obtain a coordinate C(34, 21)=(1.77, 7.07) on the coordinate system of the radar 21, and detect the object 34 through the radar 22 to obtain a coordinate C(34, 22)=(−1.25, 3.75) on the coordinate system of the radar 22. The controller 100 may also obtain a distance between the coordinate C(34, 22) and the radar 22, and draw a circle 53 with a radius of the distance while taking the object 34 as a center, where a circle equation of the circle 53 may be (x−1.77)²+(y−7.07)²=(−1.25)²+ (3.75)². The controller 100 may further calculate a distance between the candidate coordinate C(41, 21) and the coordinate C(34, 21). The distance between the candidate coordinate C(41, 21) and the coordinate C(34, 21) is equal to the distance between the coordinate C(34, 22) and the radar 22, which means that the position 41 is located on the circle 53. Accordingly, the controller 100 may determine that the candidate coordinate C(41, 21) is the radar coordinate of the radar 22. The controller 100 may also calculate a distance between the candidate coordinate C(42, 21) and the coordinate C(34, 21). The distance between the candidate coordinate C(42, 21) and the coordinate C(34, 21) is not equal to the distance between the coordinate C(34, 22) and the radar 22, which means that the position 42 is not on the circle 53. Accordingly, the controller 100 may determine that the candidate coordinate C(42, 21) is not the radar coordinate of the radar 22.

Referring back to FIG. 2, in step S206, the controller 100 may determine whether a count value is greater than zero. The controller 100 may pre-store a count value with an initial value of zero, where the count value is a natural number. If the controller determines that the count value is greater than zero, step S207 is executed. If the controller 100 determines that the count value is equal to zero, then step S208 is executed.

The count value represents a number of times of coordinate rotations required to map the radar coordinate obtained in step S204 or S205 to the reference coordinate system. In step S207, the controller 100 may rotate the radar coordinate of the second radar according to the count value to obtain the radar coordinate of the second radar on the reference coordinate system. For the coordinates in the two-dimensional space, the controller 100 may perform coordinate rotation according to equation (1), where x represents an x-coordinate before rotation, y represents a y-coordinate before rotation, x′ represents an x-coordinate after rotation, y′ represents a y-coordinate after rotation, and θ represents a rotation angle.

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ] \qquad ( 1 )$$

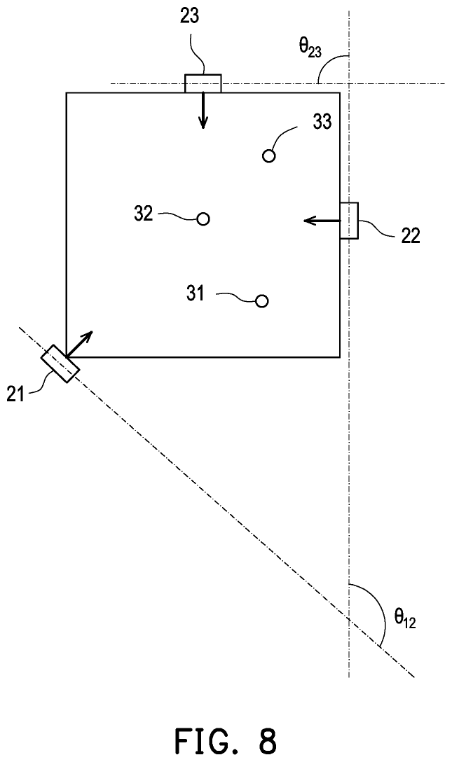

FIG. 8 is a schematic diagram of mapping a radar coordinate of a radar to the reference coordinate system according to an embodiment of the disclosure, where an included angle θ₁₂ may represent an included angle between the radar 21 and the radar 22 (for example: or an included angle between a lateral direction of the radar 21 and a lateral direction of the radar 22, where the lateral direction represents a direction perpendicular to a wave beam emitted by the radar), and the included angle θ₂₃ may represent an included angle between the radar 22 and the radar 23. It is assumed that the coordinate system corresponding to the radar 21 is the reference coordinate system, the radar coordinate of the radar 22 on the reference coordinate system is known to the controller 100, the included angle θ₁₂ is known to the controller 100, and the count value is 1. The controller 100 may perform a process similar to steps S201 to S205 to obtain the radar coordinate of the radar 23 on the coordinate system corresponding to the radar 22. In order to further obtain the radar coordinate of the radar 23 on the reference coordinate system corresponding to the radar 21, the controller 100 may rotate the radar coordinate of the radar 23 on the coordinate system corresponding to the radar 22 once according to the included angle θ₁₂ based on the count value, so as to obtain the radar coordinate of the radar 23 on the reference coordinate system corresponding to the radar 23. The controller 100 may rotate the radar coordinate of the radar 23 according to equation (2) to map the radar coordinate of the radar 23 to the reference coordinate system, where x(23, 22) represents an x-coordinate of the radar 23 on the coordinate system corresponding to the radar 22, y(23, 22) represents a y-coordinate of the radar 23 on the coordinate system corresponding to the radar 22, x(23, 21) represents an x-coordinate of the radar 23 on the reference coordinate system corresponding to the radar 21, y(23, 21) represents a y-coordinate of the radar 23 on the reference coordinate system corresponding to the radar 21, and θ₁₂ represents an included angle between the radar 21 and the radar 22.

$$[ \begin{matrix}x ( 23 , 21 ) \\ y ( 23 , 21 )\end{matrix} ] = [ \begin{matrix}cos {θ}_{12} & - sin {θ}_{12} \\ sin {θ}_{12} & cos {θ}_{12}\end{matrix} ] [ \begin{matrix}x ( 23 , 22 ) \\ y ( 23 , 22 )\end{matrix} ] \qquad ( 2 )$$

Referring back to FIG. 2, in step S208, the controller 100 may calculate an included angle θ₀ between the first radar and the second radar (or an included angle between a lateral direction of the first radar and the lateral direction of the second radar, where the first lateral direction is a direction perpendicular to a wave beam emitted by the first radar, and the second lateral direction is a direction perpendicular to a wave beam emitted by the second radar). In addition, the controller 100 may add the count value by one to update the count value.

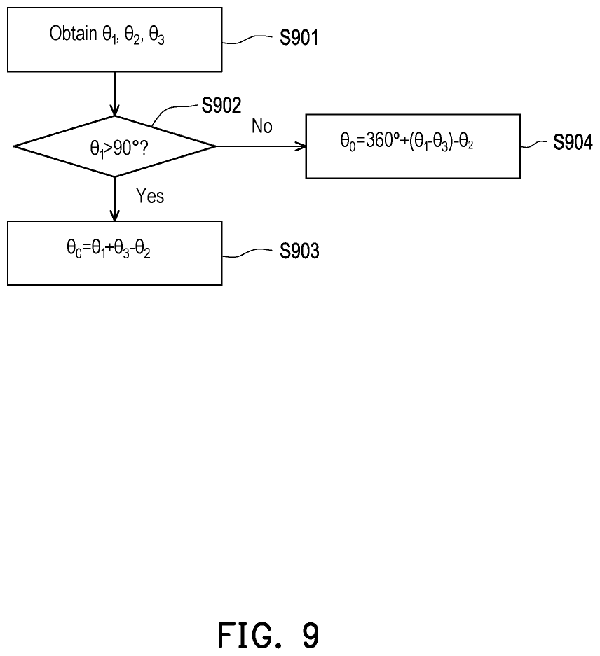

FIG. 9 is a flowchart of obtaining the included angle θ₀ according to an embodiment of the disclosure. In step S901, the controller 100 may obtain a first angle of arrival θ₁ according to the first coordinate, obtain a second angle of arrival θ₂ according to the third coordinate, and obtain an included angle θ₃ formed by the radar coordinate of the first radar (or referred to as a second radar coordinate), the first coordinate and the radar coordinate of the second radar. In an embodiment, if the coordinate system corresponding to the first radar is the reference coordinate system, the radar coordinate of the first radar may be an origin of the reference coordinate system.

In step S902, the controller 110 may determine whether the first angle of arrival θ₁ is greater than 90 degrees. If the first angle of arrival θ₁ is greater than 90 degrees, step S903 is executed. If the first angle of arrival θ₁ is less than or equal to 90 degrees, step S904 is executed.

In step S903, the controller 110 may calculate the included angle θ₀ according to equation (3), wherein θ₁ is the first angle of arrival, θ₂ is the second angle of arrival, and θ₃ is the included angle formed by the radar coordinate of the first radar, the first coordinate and the radar coordinate of the second radar.

$${θ}_{0} = {θ}_{1} + {θ}_{3} - {θ}_{2} \qquad ( 3 )$$

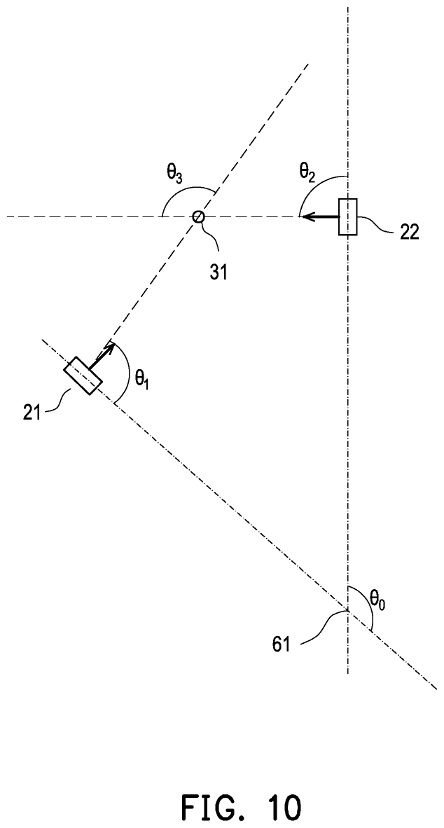

FIG. 10 is a schematic diagram of obtaining the included angle θ₀ when the included angle θ₁ is greater than 90 degrees according to an embodiment of the disclosure. The controller 110 may obtain the first angle of arrival θ₁ according to the coordinate C(31, 21), obtain the second angle of arrival θ₂=135° according to the coordinate C(31, 22), and obtain the included angle θ₃=153.43° formed by the radar coordinate of the radar 21, the first coordinate C(31, 21) and the radar coordinate of the second radar. If the first angle of arrival θ₁ is greater than 90 degrees, the controller 110 may derive (180°−θ₀)+θ₁+(180°−θ₂)+θ₃=360° according to the sum of interior angles of a quadrilateral formed by the radar coordinate of the radar 21, the coordinate C(31, 21) of the object 31, the radar coordinate of the radar 22, and an intersection 61 between the lateral direction of the radar 21 and the lateral direction of the radar 22 being 360°, so as to obtain the equation (3).

Referring back to FIG. 9, in step S904, controller 110 may calculate the included angle θ₀ according to equation (4), where θ₁ is the first angle of arrival, θ₂ is the second angle of arrival, and θ₃ is the included angle formed by the radar coordinate of the first radar, the first coordinate and the radar coordinate of the second radar.

$${θ}_{0} = 360 ° + ( {θ}_{1} - {θ}_{3} ) - {θ}_{2} \qquad ( 4 )$$

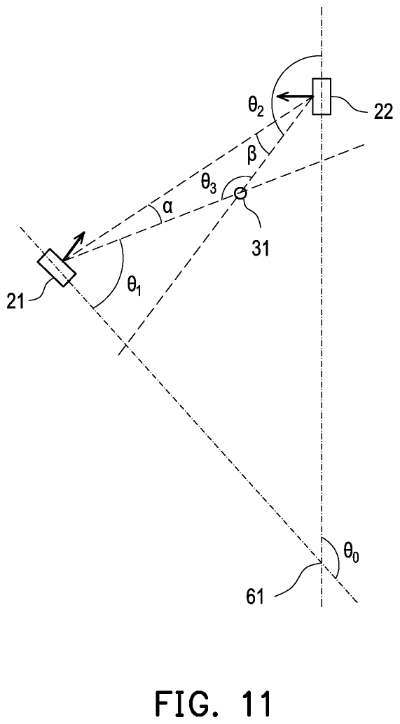

FIG. 11 is a schematic diagram of obtaining the included angle θ₀ when the included angle θ₁ is less than or equal to 90 degrees according to an embodiment of the disclosure. The controller 110 may obtain the first angle of arrival θ₁=63.43° according to the coordinate C(31, 21), obtain the second angle of arrival θ₂=135° according to the coordinate C(31, 22), and the included angle θ₃=153.43° formed by the radar coordinate of the radar 21, the first coordinate C(31, 21) and the radar coordinate of the second radar. If the first angle of arrival θ₁ is less than or equal to 90 degrees, the controller 110 may derive (180°−θ₀)+ (θ₁+β)+ (180°−θ₂+α)=180° and α+β=180°−θ₃ according to a sum of interior angles of a triangle formed by the radar coordinate of the radar 21, the coordinate C(31, 21) of the object 31, and the radar coordinate of the radar 22 being 180°, so as to obtain the equation (4), where a is an included angle formed by the coordinate C(31, 21) of the object 31, the radar coordinate of the radar 21, and the radar coordinate of the radar 22, and β is an included angle formed by the coordinate C(31, 21) of the object 31, the radar coordinate of the radar 22, and the radar coordinate of the radar 21. The controller 100 may calculate the included angle θ₀=135° according to the equation (4).

Referring back to FIG. 2, in step S209, the controller 100 may output the included angle θ₀ and the radar coordinate of the second radar (for example, the radar 22) on the coordinate system (for example, the reference coordinate system) corresponding to the first radar.

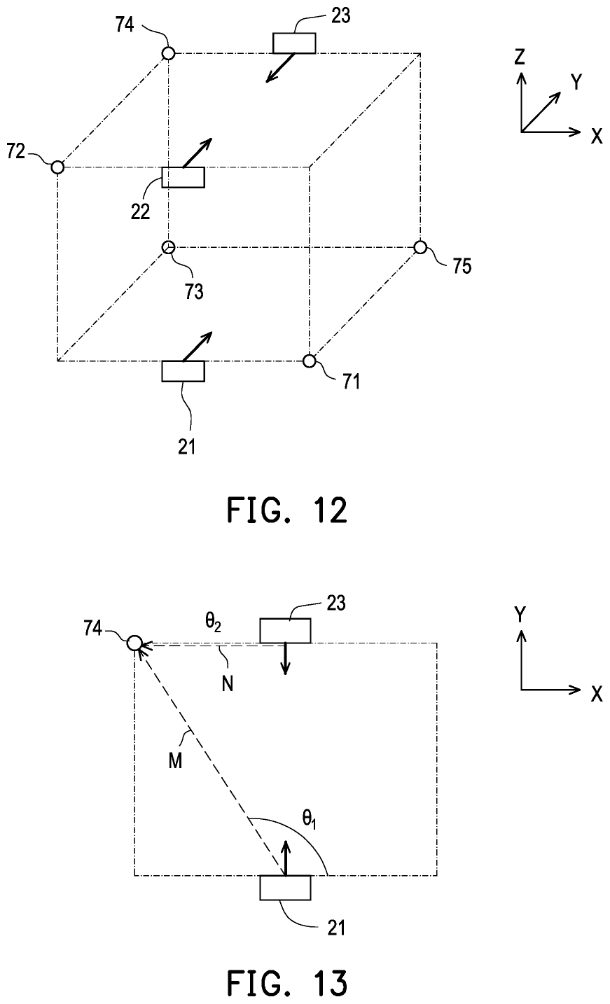

FIG. 12 is a schematic diagram of radars and objects in a three-dimensional space according to an embodiment of the disclosure. It is assumed that a plurality of radars including a radar 21, a radar 22 and a radar 23 are set in a three-dimensional space, and objects 71, 72, 73, 74 and 75 exist in the three-dimensional space. The controller 100 may detect the object 71, the object 72, the object 73 and the object 74 through the radar 21 to respectively obtain a coordinate C(71, 21)=(2, 0, 0), a coordinate C(72, 21)=(−2, 0, 4), a coordinate C(73, 21)=(−2, 4, 0) and a coordinate C(74, 21)−(−2, 4, 4) on the coordinate system (or referred to as the reference coordinate system) corresponding to the radar 21. The controller 100 may detect the object 71, the object 72, the object 73 and the object 74 through the radar 22 to respectively obtain a coordinate C(71, 22)=(2, 0,−4), a coordinate C(72, 22)=(−2, 0, 0), a coordinates C(73, 22)=(−2, 4,−4) and a coordinate C(74, 22)=(−2, 4, 0) on the coordinate system corresponding to the radar 22. The controller 100 may detect the object 72, the object 73, the object 74 and the object 75 through the radar 23 to respectively obtain a coordinate C(72, 23)=(2, 4, 0), a coordinate C(73, 23)=(2, 0,−4), a coordinate C(74, 23)=(2, 0, 0) and a coordinate C(75, 23)=(−2, 0,−4) on the coordinate system corresponding to the radar 23.

The controller 100 may use the radar coordinate of the radar 21 as an origin (0,0,0) of the reference coordinate system. The controller 100 may calculate a distance between the object 71 and the radar 22 to be 4.47 according to the coordinate C(71, 22) of the object 71, calculate a distance between the object 72 and the radar 22 to be 2 according to the coordinate C(72, 22) of the object 72, and calculate a distance between the object 73 and the radar 22 to be 6 according to the coordinate C(73, 22) of the object 73. The controller 110 may obtain a spherical equation (a) of (x−2)₂+ (y)²+ (z)²=4.472, which has a radius of the distance 4.47 and takes the object 71 as a center; obtain a spherical equation (b) of (x+2)²+ (y)²+ (z−4)²=2², which has a radius of the distance 2 and takes the object 72 as a center; and obtain a spherical equation (c) of (x+2)²+ (y−4)²+ (z)²=6², which has a radius of the distance 6 and takes the object 73 as a center.

The controller 100 may obtain two intersections of the three circles according to the spherical equations (a), (b) and (c), where coordinates of the two intersections are the two candidate coordinates of the radar 22. Then, the controller 100 may select a real radar coordinate of the radar 22 from the two candidate coordinates according to the object 74. The controller 100 may calculate a distance between the object 74 and the radar 22 to be 4.47 according to the coordinate C(74, 22) of the object 74. Then, the controller 100 may obtain a spherical equation (d) of (x+2) 2+ (y−4)²+ (z−4)²=4.472, which has a radius of the distance 4.47 and takes the object 74 as a center. The controller 100 may obtain a unique solution of the radar coordinate of the radar 22 as (0, 0, 4) according to the spherical equations (a), (b), (c) and (d).

When installing the radars, all radars may point in different directions (i.e., directions of wave beams emitted by the radars). In a practical application, in the multi-radar positioning system 10, it may be assumed that Z-axis directions of the radars are consistent. Accordingly, the controller 100 may project the coordinate of each radar onto an XY plane, thereby simplifying the calculation of the radar coordinate of each radar and the included angle between the radars. Taking the object 74 in FIG. 13 as an example, the controller 100 may project the coordinate C(74, 21)=(−2, 4, 4) of the object 74 relative to the radar 21 onto the XY plane to obtain a coordinate (−2, 4), and may project the coordinate C(74, 23)=(2, 0, 0) of the object 74 relative to the radar 23 onto the XY plane to obtain a coordinate (2, 0), as shown in FIG. 13, where θ₁=116.57° is an angle of arrival corresponding to the object 74 and the radar 21, θ₂=0° is an angle of arrival corresponding to the object 74 and the radar 23, and θ₃=63.43° is an included angle between a vector M=(−2, 4) from the radar 21 to the object 74 and a vector N=(2, 0) from the radar 23 to the object 74. The controller 100 may calculate the included angle θ₀=θ₁+θ₃−θ₂=180° between the radar 21 and the radar 23 according to the equation (3) in response to the angle of arrival θ₁ being greater than 90 degrees.

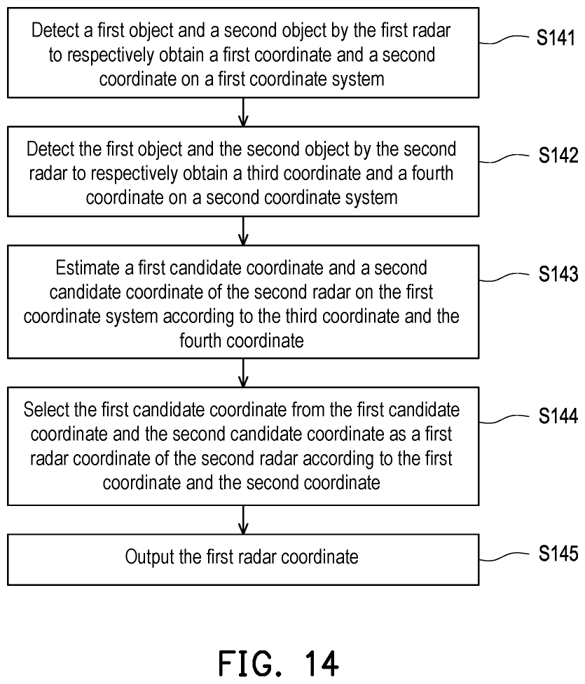

FIG. 14 is a flowchart of a positioning method according to an embodiment of the disclosure, where the positioning method may be implemented by the multi-radar positioning system 10 shown in FIG. 1. In step S141, a first object and a second object are detected by a first radar to respectively obtain a first coordinate and a second coordinate on a first coordinate system. In step S142, the first object and the second object are detected by a second radar to respectively obtain a third coordinate and a fourth coordinate on a second coordinate system. In step S143, a first candidate coordinate and a second candidate coordinate of the second radar on the first coordinate system are estimated according to the third coordinate and the fourth coordinate. In step S144, the first candidate coordinate is selected from the first candidate coordinate and the second candidate coordinate as a first radar coordinate of the second radar according to the first coordinate and the second coordinate. In step S145, the first radar coordinate is output.

In summary, the multi-radar positioning system of the disclosure may automatically calculate relative positions of the radars without obtaining a global map, and then convert the detection results of the radars to a same coordinate system. Therefore, the disclosure may save a time required for measuring the global map, and further accelerate the configuration of the multi-radar positioning system.

What is claimed is:

1. A multi-radar positioning system, comprising:
a first radar, detecting a first object and a second object to respectively obtain a first coordinate and a second coordinate on a first coordinate system;
a second radar, detecting the first object and the second object to respectively obtain a third coordinate and a fourth coordinate on a second coordinate system; and
a controller, communicatively coupled to the first radar and the second radar and configured to:
estimate a first candidate coordinate and a second candidate coordinate of the second radar on the first coordinate system according to the third coordinate and the fourth coordinate;
select the first candidate coordinate from the first candidate coordinate and the second candidate coordinate as a first radar coordinate of the second radar according to the first coordinate and the second coordinate; and
output the first radar coordinate.

2. The multi-radar positioning system according to claim 1, wherein the controller is further configured to:
detect a third object through the first radar to obtain a fifth coordinate on the first coordinate system;
detect the third object through the second radar to obtain a sixth coordinate on the second coordinate system; and
select the first candidate coordinate as the first radar coordinate according to the fifth coordinate and the sixth coordinate.

3. The multi-radar positioning system according to claim 2, wherein the controller is further configured to:
calculate a first distance between the first candidate coordinate and the fifth coordinate;
obtain a second distance between the sixth coordinate and the second radar; and
select the first candidate coordinate as the first radar coordinate, in response to the first distance being equal to the second distance.

4. The multi-radar positioning system according to claim 1, wherein the controller is further configured to:
obtain a first vector from the first candidate coordinate to the first coordinate;
obtain a second vector from the first candidate coordinate to the second coordinate;
obtain a first angle of arrival according to the third coordinate;
obtain a second angle of arrival according to the fourth coordinate; and
select the first candidate coordinate as the first radar coordinate according to the first vector, the second vector, the first angle of arrival, and the second angle of arrival.

5. The multi-radar positioning system according to claim 4, wherein the controller is further configured to:
rotate the first vector according to the first angle of arrival to obtain a third vector;
rotate the second vector according to the second angle of arrival to obtain a fourth vector;
calculate a first included angle between the third vector and the fourth vector; and
select the first candidate coordinate as the first radar coordinate, in response to an absolute value of the first included angle corresponding to the first candidate coordinate being smaller than an absolute value of a second included angle corresponding to the second candidate coordinate.

6. The multi-radar positioning system according to claim 1, wherein the controller is further configured to:
obtain a first angle of arrival according to the first coordinate;
obtain a second angle of arrival according to the third coordinate;
obtain a first included angle formed by a second radar coordinate of the first radar, the first coordinate, and the first radar coordinate;
calculate a second included angle according to the first angle of arrival, the second angle of arrival, and the first included angle, wherein the second included angle indicates an included angle between a first lateral direction of the first radar and a second lateral direction of the second radar; and
output the second included angle.

7. The multi-radar positioning system according to claim 6, wherein the controller is further configured to:
calculate the second included angle according to a difference between a sum of the first angle of arrival and the first included angle and the second angle of arrival, in response to the first angle of arrival being greater than 90 degrees.

8. The multi-radar positioning system according to claim 6, wherein the controller is further configured to:
calculate a first difference between the first angle of arrival and the first included angle and calculate the second included angle according to a second difference between the first difference and the second angle of arrival, in response to the first angle of arrival being less than or equal to 90 degrees.

9. The multi-radar positioning system according to claim 6, wherein the controller is further configured to:
update a count value stored in the controller according to the second included angle.

10. The multi-radar positioning system according to claim 9, further comprising:
a third radar, communicatively coupled to the controller, wherein the controller is further configured to:
obtain a second radar coordinate of the third radar on the second coordinate system;
rotate the second radar coordinate according to the count value to obtain a third radar coordinate of the third radar on the first coordinate system; and
output the third radar coordinate.

11. The multi-radar positioning system according to claim 1, wherein the controller is further configured to:
determine a first distance between the first object and the second radar according to the third coordinate;
determine a second distance between the second object and the second radar according to the fourth coordinate; and
determine that a fifth coordinate is one of the first candidate coordinate and the second candidate coordinate, in response to a third distance between the fifth coordinate and the first coordinate on the first coordinate system being equal to the first distance and a fourth distance between the fifth coordinate and the second coordinate being equal to the second distance.

12. A positioning method, adapted to a multi-radar positioning system comprising a first radar and a second radar, comprising:
detecting a first object and a second object by the first radar to respectively obtain a first coordinate and a second coordinate on a first coordinate system;
detecting the first object and the second object by the second radar to respectively obtain a third coordinate and a fourth coordinate on a second coordinate system;
estimating a first candidate coordinate and a second candidate coordinate of the second radar on the first coordinate system according to the third coordinate and the fourth coordinate;
selecting the first candidate coordinate from the first candidate coordinate and the second candidate coordinate as a first radar coordinate of the second radar according to the first coordinate and the second coordinate; and
outputting the first radar coordinate.

13. The positioning method according to claim 12, wherein the step of selecting the first candidate coordinate from the first candidate coordinate and the second candidate coordinate as the first radar coordinate of the second radar according to the first coordinate and the second coordinate comprises:
detecting a third object by the first radar to obtain a fifth coordinate on the first coordinate system;
detecting the third object by the second radar to obtain a sixth coordinate on the second coordinate system; and
selecting the first candidate coordinate as the first radar coordinate according to the fifth coordinate and the sixth coordinate.

14. The positioning method according to claim 13, wherein the step of selecting the first candidate coordinate as the first radar coordinate according to the fifth coordinate and the sixth coordinate comprises:
calculating a first distance between the first candidate coordinate and the fifth coordinate;
obtaining a second distance between the sixth coordinate and the second radar; and
selecting the first candidate coordinate as the first radar coordinate, in response to the first distance being equal to the second distance.

15. The positioning method according to claim 12, wherein the step of selecting the first candidate coordinate from the first candidate coordinate and the second candidate coordinate as the first radar coordinate of the second radar according to the first coordinate and the second coordinate comprises:
obtaining a first vector from the first candidate coordinate to the first coordinate;
obtaining a second vector from the first candidate coordinate to the second coordinate;
obtaining a first angle of arrival according to the third coordinate and obtaining a second angle of arrival according to the fourth coordinate; and
selecting the first candidate coordinate as the first radar coordinate according to the first vector, the second vector, the first angle of arrival, and the second angle of arrival.

16. The positioning method according to claim 15, wherein the step of selecting the first candidate coordinate as the first radar coordinate according to the first vector, the second vector, the first angle of arrival, and the second angle of arrival comprises:
rotating the first vector according to the first angle of arrival to obtain a third vector;
rotating the second vector according to the second angle of arrival to obtain a fourth vector;
calculating a first included angle between the third vector and the fourth vector; and
selecting the first candidate coordinate as the first radar coordinate, in response to an absolute value of the first included angle corresponding to the first candidate coordinate being smaller than an absolute value of a second included angle corresponding to the second candidate coordinate.

17. The positioning method according to claim 12, further comprising:
obtaining a first angle of arrival according to the first coordinate;
obtaining a second angle of arrival according to the third coordinate;
obtaining a first included angle formed by a second radar coordinate of the first radar, the first coordinate, and the first radar coordinate;
calculating a second included angle according to the first angle of arrival, the second angle of arrival, and the first included angle, wherein the second included angle indicates an included angle between a first lateral direction of the first radar and a second lateral direction of the second radar; and
outputting the second included angle.

18. The positioning method according to claim 17, wherein the step of calculating the second included angle according to the first angle of arrival, the second angle of arrival, and the first included angle comprises:
calculating the second included angle according to a difference between a sum of the first angle of arrival and the first included angle and the second angle of arrival, in response to the first angle of arrival being greater than 90 degrees.

19. The positioning method according to claim 17, wherein the step of calculating the second included angle according to the first angle of arrival, the second angle of arrival, and the first included angle comprises:
calculating a first difference between the first angle of arrival and the first included angle and calculating the second included angle according to a second difference between the first difference and the second angle of arrival, in response to the first angle of arrival being less than or equal to 90 degrees.

20. The positioning method according to claim 17, further comprising
updating a count value according to the second included angle.
